(19) United States
(12) Patent Application Publication
(10) Pub. No.: US 2022/0343122 A1
(43) Pub. Date: Oct. 27, 2022

(54) DATA ANALYSIS APPARATUS, DATA ANALYSIS METHOD, AND DATA ANALYSIS PROGRAM

(71) Applicant: Hitachi, Ltd., Tokyo (JP)

(72) Inventors: Wataru TAKEUCHI, Tokyo (JP); Shunki NAKAGAWA, Tokyo (JP); Shinji TARUMI, Tokyo (JP)

(21) Appl. No.: 17/721,648

(22) Filed: Apr. 15, 2022

(30) Foreign Application Priority Data
Apr. 22, 2021 (JP) 2021-072448

(51) Int. Cl. G06K 9/62

(52) U.S. Cl. CPC G06K 9/6298; G06K 9/6262

(57) ABSTRACT

To implement a highly accurate prediction analysis that does not depend on data amount. A data analysis apparatus has a processor that is configured to execute: an acquisition processing of acquiring a first statistical model based on a distribution of actual measurement results of a group and a second statistical model based on a distribution of a first actual measurement result of first samples having a smaller number of samples than the number of samples of the group; a calculation processing of calculating correction information indicating a difference between the first statistical model and the second statistical model; a learning processing of generating a first prediction model by performing machine learning using the first actual measurement result and first feature amount data corresponding to the first actual measurement result; and a correction processing of correcting a first prediction result , and outputting a second prediction result.

### CLAIM OF PRIORITY

The present application claims priority from Japanese patent application JP 2021-072448 filed on Apr. 22, 2021, the content of which is hereby incorporated by reference into this application.

### BACKGROUND OF THE INVENTION

### 1. Field of the Invention

The present invention relates to a data analysis apparatus, a data analysis method, and a data analysis program for analyzing data.

### 2. Description of the Related Art

When prediction analysis using machine learning is performed, the number of data samples used for learning needs to be at least about 50. When learning is performed using limited data, so-called over-fitting may occur, in which a prediction model generated by learning excessively conforms to the data. For example, when a future disease risk is predicted and learning can only be performed using data derived from a single facility, it is difficult to eliminate an influence of baseline characteristics such as patient attributes and facility features related to the facility data. Furthermore, it may be difficult to perform analysis using a large amount of facility data, and it may take a long time to collect a target amount of data.

For example, PTL 1 (JP-A-2017-102710) discloses a data analysis apparatus that derives a regression equation necessary for statistical analysis in a short period of time. The regression equation enables prediction with accuracy that satisfies requirements of an application even in a situation in which sufficient data is not collected. The data analysis apparatus extracts, for a regression equation derived using a simple pseudo data set having the same attributes as a part of attributes of data collected in a target field to be predicted, (i) a variable obtained by adding an explanatory variable for correcting a deviation in distribution from the collected data to an explanatory variable useful for prediction of an objective variable and (ii) data that is a correct value for the objective variable from the target field, extracts an explanatory variable that exerts a significant difference in distribution between the extracted data and a data set collected in a field different from the target field from the data that is a correct value, and creates a pseudo data set that has the same feature amount as that of the collected data and is useful for prediction of the objective variable in the target field based on data having a large scale for the explanatory variable that exerts the significant difference.

However, in PTL 1 described above, it is necessary to collect a large-scale data set such as Web data, sensor data, and large-scale questionnaire data. Further, it is necessary to generate the simple pseudo data set from the collected large-scale data set, derive the regression equation using the simple pseudo data set, and add the explanatory variable for correcting a deviation in distribution of the collected data. As described above, the data analysis apparatus of PTL 1 is premised on collection of a large-scale data set. Therefore, when a large-scale data set cannot be collected, data analysis cannot be performed.

On the other hand, when prediction is performed as a service, prediction with a certain degree of accuracy from the beginning may be a requirement for collecting data for a long period of time or at a high cost, or it may be desired to know in advance a range of prediction performance in a certain degree.

### SUMMARY OF THE INVENTION

An object of the invention is to implement a highly accurate prediction analysis independent of data amount.

A data analysis apparatus according to one aspect of the invention disclosed in the present application includes a processor that executes a program and a storage device that stores the program. The processor is configured to execute: an acquisition processing of acquiring a first statistical model based on a distribution of actual measurement results of a group and a second statistical model based on a distribution of a first actual measurement result of first samples having a smaller number of samples than the number of samples of the group; a calculation processing of calculating correction information indicating a difference between the first statistical model and the second statistical model acquired by the acquisition processing; a learning processing of generating a first prediction model by performing machine learning using the first actual measurement result and first feature amount data corresponding to the first actual measurement result; and a correction processing of correcting a first prediction result output by inputting second feature amount data of second samples different from the first samples to the first prediction model generated by the learning processing using the correction information calculated by the calculation processing, and outputting a second prediction result.

According to a representative embodiment of the invention, it is possible to implement highly accurate prediction analysis independent of data amount. Problems, configurations, and effects other than those described above will become apparent from the following description of the embodiment.

### BRIEF DESCRIPTION OF THE DRAWINGS

FIG. 1 is a schematic diagram showing an example of learning performed by a data analysis apparatus;

FIG. 2 is a block diagram showing an example of a hardware configuration of the data analysis apparatus;

FIG. 3 is a schematic diagram showing an example of correction information;

FIG. 4 is a schematic diagram showing an example of prediction target data and an actual measurement result;

FIG. 5 is a schematic diagram showing an example of a first prediction result;

FIG. 6 is a schematic diagram showing an example of a second prediction result;

FIG. 7 is a graph showing prediction accuracy of the second prediction result;

FIG. 8 is a flowchart showing a first example of a learning processing procedure performed by the data analysis apparatus; and

FIG. 9 is a flowchart showing a second example of the learning processing procedure performed by the data analysis apparatus.

### DESCRIPTION OF THE PREFERRED EMBODIMENTS

### Learning Example

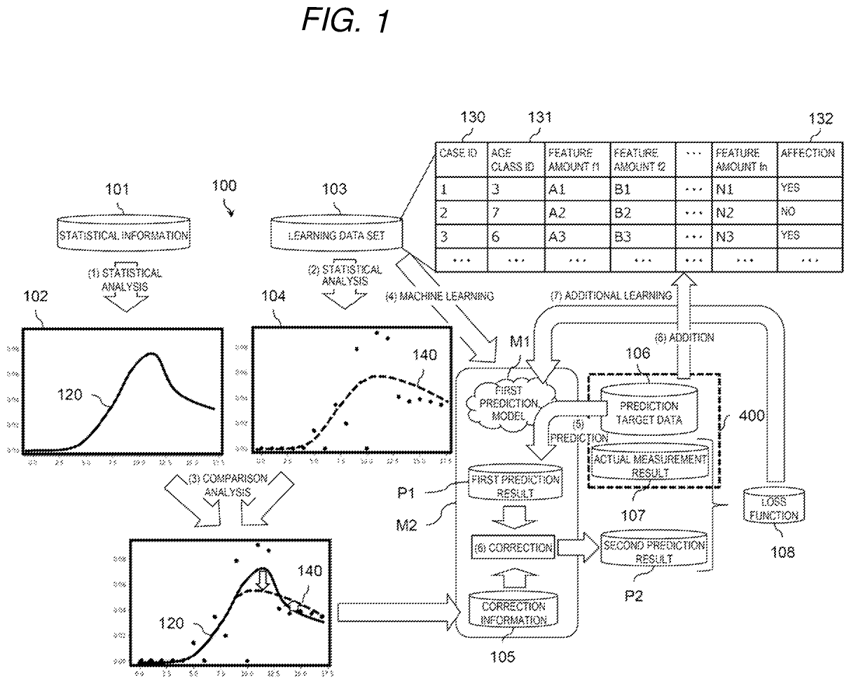

FIG. 1 is a schematic diagram showing an example of learning performed by a data analysis apparatus. In FIG. 1, learning in which a data analysis apparatus 100 predicts an affection risk of lifestyle disease will be described as an example. Statistical information 101 is, for example, statistical data indicating age-based affection rates of nationwide lifestyle diseases obtained based on large-scale data such as affection rates of lifestyle diseases using a certain group, for example, nationwide adults as samples. An affection distribution 102 of nationwide lifestyle diseases (hereinafter, simply referred to as the first affection distribution 102) is a histogram (not illustrated) in which ages in the statistical information 101 are classified by age class IDs of age groups and affection rates for the age class IDs are plotted. That is, a horizontal axis represents the age class IDs, and a vertical axis represents the affection rates of lifestyle diseases. A model generated by performing curve fitting on this histogram is a first statistical model 120.

In this way, the statistical information 101 is statistically analyzed 1, and the first affection distribution 102 and the first statistical model 120 are obtained. In the data analysis apparatus 100, the statistical information 101 and large-scale data that is the source of the statistical information 101 are not necessary, and it is sufficient that the first statistical model 120 is acquired.

A learning data set 103 is, for example, a combination of learning data and correct answer data specified by cases in a certain facility A such as a hospital. That is, the learning data set 103 is not an enormous number of samples as that in the statistical information 101, but a combination of the learning data and the correct answer data related to cases having a smaller number of samples than the number of samples in the statistical information 101. Specifically, for example, the learning data set 103 includes, as fields, a case ID 130, an age class ID 131, n (n is an integer of 1 or more) feature amounts f1 to fn (when the feature amounts f1 to fn are not distinguished from each other, they are simply referred to as feature amounts f), and affection 132.

A combination of values of fields in the same row defines an entry of one case.

The case ID 130 is identification information for uniquely identifying a case. The age class ID 131 is identification information for uniquely identifying an age class. The feature amount f is quantity data indicating a feature in a case. Specifically, for example, the feature amount f includes blood pressure, a blood glucose level, an insulin dose, and the like. The feature amount f is learning data. The age may also be treated as the feature amount, but in this example, the age is treated as the age class ID outside the feature quantity f. The affection 132 is presence or absence of affected lifestyle disease specified by a case. The affection 132 is correct answer data.

The learning data set 103 is statistically analyzed 2, and an affection distribution of a certain facility A (hereinafter, simply referred to as a second affection distribution 104) and a second statistical model 140 are obtained. The horizontal axis represents the age class IDs, and the vertical axis represents the affection rates of lifestyle diseases. The second statistical model 140 is a model generated by curve fitting points (cases) of the second affection distribution 104. The data analysis apparatus 100 may generate the second statistical model 140 from the learning data set 103 by a known method, or may acquire the second statistical model 140 from outside.

The data analysis apparatus 100 compares and analyzes 3 the first statistical model 120 and the second statistical model 140 to generate correction information 105. The correction information 105 is, for example, information indicating a difference between the first statistical model 120 and the second statistical model 140 for each age class ID 131 on the horizontal axis.

The data analysis apparatus 100 generates a first prediction model M1 by machine learning 4 of the learning data set 103. The data analysis apparatus 100 inputs prediction target data 106 to the first prediction model M1 to predict 5 a first prediction result P1. The prediction target data 106 is, for example, data defined by the case ID 130, the age class ID 131, and the feature amount f of a facility B. The first prediction result P1 is, for example, a probability (affection probability) indicating an affection risk of a lifestyle disease.

The data analysis apparatus 100 corrects 6 the first prediction result P1 with the correction information 105 and outputs the second prediction result. The first prediction model M1 and the correction 6 are a second prediction model M2. The data analysis apparatus 100 generates a loss function 108 using the second prediction result P2 and an actual measurement result 107, executes additional learning 7 such that an output of the loss function 108 is minimized, and adjusts a weight of the first prediction model. As a result, the first prediction model M1 is updated. The actual measurement result 107 is the affection 132 corresponding to the prediction target data 106.

Thereafter, each time the prediction target data 106 of another facility is newly obtained, the data analysis apparatus 100 outputs the first prediction result P1 from the latest first prediction model M1, corrects 6 the first prediction result P1 with the correction information 105 to output the second prediction result P2, executes additional learning 7 such that the output of the loss function 108 is minimized, and adjusts the weight of the first prediction model. In this way, by using the correction information 105, it is possible to implement highly accurate prediction analysis that does not depend on the data amount even when the number of entries of the learning data set 103 is small. When the prediction target data is additionally acquired, the first prediction model is updated, and thus the prediction accuracy of the first prediction result P1 is improved.

In addition, the data analysis apparatus 100 may add 8 the prediction target data 106 and the actual measurement result 107 to the learning data set 103. As a result, the statistical analysis 2 is executed again in the added learning data set 103, and the second affection distribution 104 and the second statistical model 140 are updated. The data analysis apparatus 100 updates the correction information 105 by comparing and analyzing (3) the first statistical model 120 and the updated second statistical model 140. By applying the updated correction information 105 in the correction (6), the prediction accuracy of the second prediction result P2 is improved.

When the addition (8) is executed, the data analysis apparatus 100 may execute at least one of updating of the second affection distribution 104 and the second statistical model 140 and updating of the correction information 105 by re-executing the statistical analysis (2).

### <Hardware Configuration Example of Data Analysis Apparatus 100>

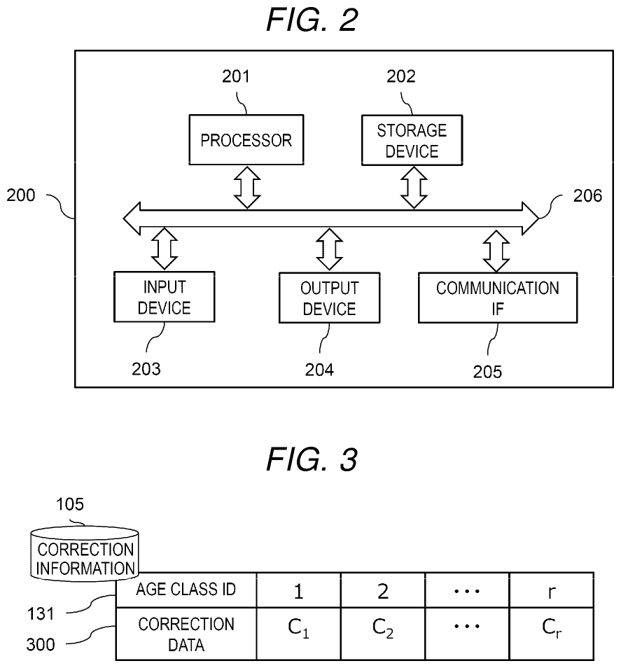

FIG. 2 is a block diagram showing an example of a hardware configuration of the data analysis apparatus 100. The data analysis apparatus 100 includes a processor 201, a storage device 202, an input device 203, an output device 204, and a communication interface (communication IF) 205. The processor 201, the storage device 202, the input device 203, the output device 204, and the communication IF 205 are connected by a bus 206. The processor 201 controls the data analysis apparatus 100. The storage device 202 serves as a work area of the processor 201. Further, the storage device 202 is a non-temporary or temporary recording medium that stores various programs and data. The storage device 202 is, for example, a read only memory (ROM), a random access memory (RAM), a hard disk drive (HDD), and a flash memory. The input device 203 inputs data. Examples of the input device 203 include a keyboard, a mouse, a touch panel, a numeric keypad, a scanner, and a microphone. The output device 204 outputs data. Examples of the output device 204 include a display, a printer, and a speaker. The communication IF 205 is connected to a network, and transmits and receives data.

### <Example of Various Data>

FIG. 3 is a schematic diagram showing an example of the correction information 105. The correction information 105 is correction data 300 for each age class ID 131. When values of the correction data 300 (referred to as correction values) C₁, C₂, . . . Cᵣ (r is the value of the age class ID 131) are not distinguished from each other, they are simply referred to as correction values C. The correction value Cᵣ is a difference between the value of the first statistical model 120 and the value of the second statistical model 140 at the value r of the same age class ID 131.

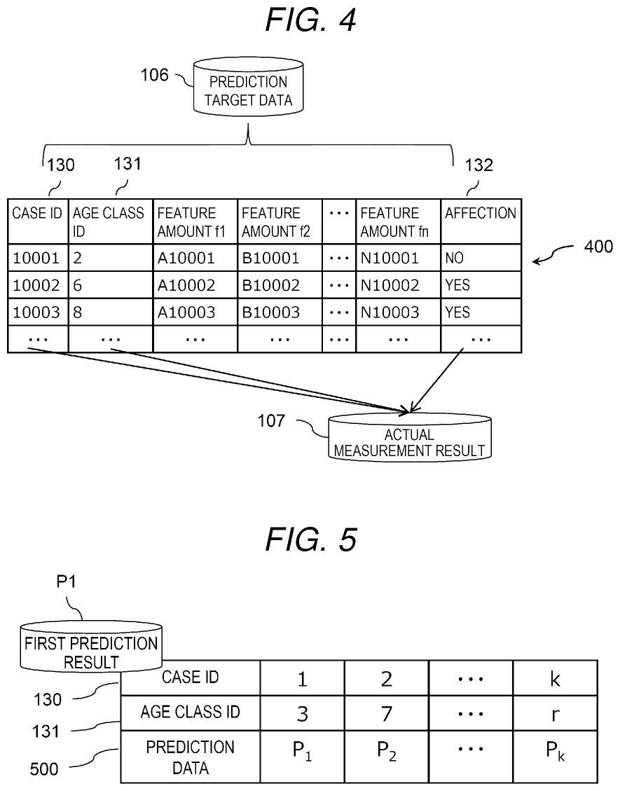

FIG. 4 is a schematic diagram showing an example of the prediction target data 106 and the actual measurement result 107. The prediction target data 106 is, for example, learning data specified by cases in the facility B different from the facility A. Specifically, for example, the prediction target data 106 includes, as fields, the case ID 130, the age class ID 131, and the n (n is an integer of 1 or more) feature amounts f1 to fn. A combination of values of fields in the same row defines an entry of learning data in one case.

The actual measurement result 107 is, for example, correct answer data specified by the cases in the facility B. Specifically, for example, the actual measurement result 107 includes the case ID 130, the age class ID 131, and the affection 132 as fields. A combination of values of fields in the same row defines an entry of correct answer data in one case. The prediction target data 106 and the actual measurement result 107 can be added to the learning data set 103 as additional learning data set 400.

FIG. 5 is a schematic diagram showing an example of the first prediction result P1. The first prediction result P1 is prediction data 500 for each case ID 130. Values of the prediction data 500 (referred to as first prediction values) Pi, P2, and Pk (k is the value of the case ID 130) of the prediction data 500 are simply referred to as first prediction values P when not distinguished from each other.

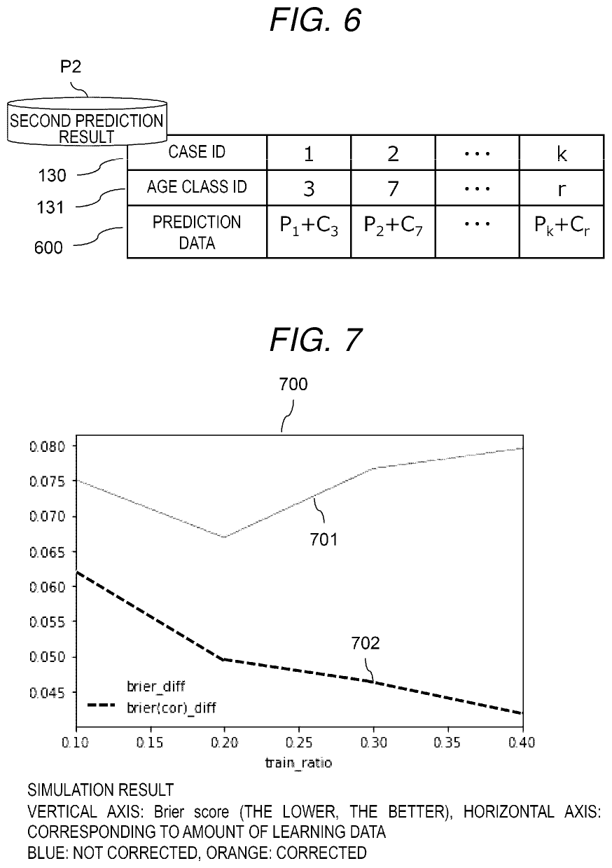

FIG. 6 is a schematic diagram showing an example of the second prediction result P2. The second prediction result P2 is prediction data 600 for each case ID 130. When values of the prediction data 600 (referred to as second prediction values) P₁+C₃, P₂+C₇, . . . , Pₖ +Cᵣ are not distinguished from one another, they are simply referred to as second prediction values P+C. In the present embodiment, the second prediction values P+C are expressed by addition of the first prediction values P and the correction values C. However, the calculation is not limited to addition, and may be multiplication, and may be calculation other than addition or multiplication as long as the correction value C is added to the first prediction value P.

FIG. 7 is a graph showing prediction accuracy of the second prediction result P2. In a graph 700, the horizontal axis corresponds to the amount of learning data, and the vertical axis represents the brightness score. The lower the score is, the higher the prediction accuracy is. A characteristic 701 indicates the prediction accuracy of the first prediction result P1 to which the correction information 105 is not applied, and a characteristic 702 indicates the prediction accuracy of the second prediction result P2 when the correction information 105 is applied to the first prediction result P1. The graph 700 indicates that the prediction accuracy of the second prediction result P2 is higher than the prediction accuracy of the first prediction result P1.

### <Examples of Learning Processing Procedure>

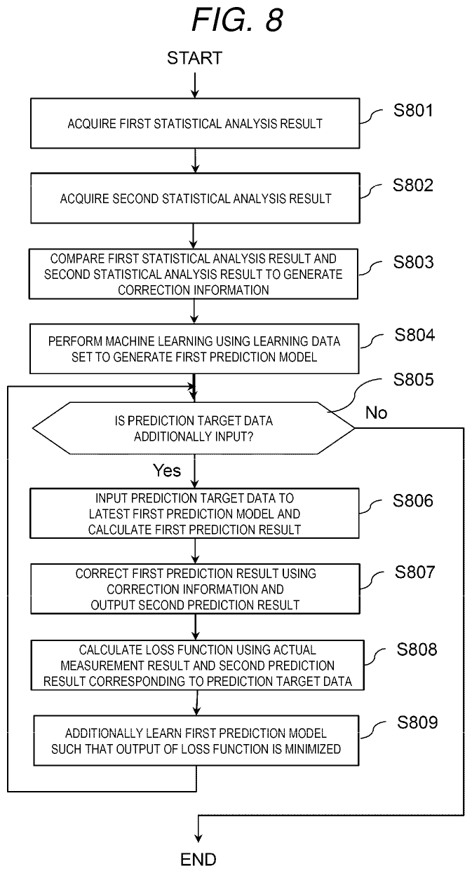

FIG. 8 is a flowchart showing a first example of a learning processing procedure performed by the data analysis apparatus 100. The data analysis apparatus 100 acquires the first affection distribution 102 and the first statistical model 120 as a first statistical analysis result (step S801). The data analysis apparatus 100 acquires the second affection distribution 104 and the second statistical model 140 as a second statistical analysis result (step S802).

The data analysis apparatus 100 compares the first statistical analysis result and the second statistical analysis result to calculate the correction information 105 as shown in the comparison analysis (3) in FIG. 1 (step S803). The data analysis apparatus 100 performs machine learning using the learning data set 103 to generate the first prediction model M1 as shown in the machine learning (4) in FIG. 1 (step S804).

The data analysis apparatus 100 determines whether the prediction target data 106 was additionally input (step S805). When the prediction target data 106 was additionally input (step S805: Yes), the data analysis apparatus 100 inputs the prediction target data 106 to the latest first prediction model M1 and calculates the first prediction result P1 (step S806). The latest first prediction model M1 is the first prediction model M1 generated by the machine learning (4) when the additional learning (7) in FIG. 1 is not executed even once, and is the first prediction model M1 updated by the additional learning executed last when the additional learning (7) in FIG. 1 is executed once or more times.

As shown in the correction (6) in FIG. 1, the data analysis apparatus 100 corrects the first prediction result P1 using the correction information 105 and outputs the corrected first prediction result P1 as the second prediction result P2 (step S807). Next, the data analysis apparatus 100 calculates the loss function 108 using the actual measurement result 107 and the second prediction result P2 corresponding to the prediction target data 106 (step S808).

Then, as shown in the additional learning (7) in FIG. 1, the data analysis apparatus 100 additionally learns the first prediction model M1 such that the output of the loss function 108 is minimized (step S809), and returns to step S805. That is, steps S806 to S809 are executed each time the prediction target data 106 of a facility C different from the facilities A and B is additionally input (step S805: Yes), and thus it is possible to output the second prediction result P2 with high accuracy.

In step S805, when the prediction target data 106 is not input (step S805: No), the learning processing ends.

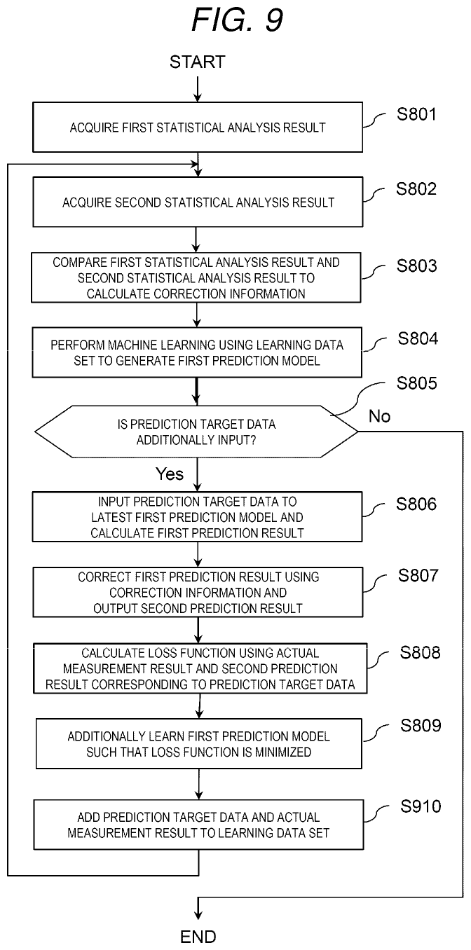

FIG. 9 is a flowchart showing a second example of the learning processing procedure performed by the data analysis apparatus 100. The second example of the learning processing procedure is an example of a case where the addition (8) of the additional learning data set 400 of FIG. 1 to the learning data set 103 is executed. The same processing as those in FIG. 8 are denoted by the same step numbers, and the description thereof will be omitted.

In the second example of the learning processing procedure, after step S809, the data analysis apparatus 100 adds the prediction target data 106 and the actual measurement result 107 (additional learning data set 400) to the learning data set 103 (step S910), and returns to step S802. In this case, in step S802, the data analysis apparatus 100 acquires the latest second statistical analysis result (the second affection distribution 104 and the second statistical model 140) of the latest learning data set 103 after the addition of the additional learning data set 400 (step S802).

Thereafter, the data analysis apparatus 100 compares the first statistical analysis result (the first affection distribution 102 and the first statistical model 120) with the latest second statistical analysis result (the second affection distribution 104 and the second statistical model 140) to update the correction information 105 (step S803). The data analysis apparatus 100 relearns the first prediction model M1 using the latest second statistical analysis result (step S804).

As a result, each time the prediction target data 106 is additionally input (step S805: Yes), the data analysis apparatus 100 executes steps S806 to S809 using the latest first prediction result P1 from the re-learned first prediction model M1 and the latest correction information 105. This makes it possible to output the second prediction result P2 with high accuracy.

In general, machine learning focuses on learning from available data. However, the data analysis apparatus 100 of the present embodiment utilizes the correction information 105 derived from large-scale data as information other than the data, and creates the first prediction model M1 and the second prediction model M2 from the learning data set 103 in which the number of cases is smaller than that of the large-scale data. Therefore, even in a situation where sufficient learning data sets necessary for machine learning are not collected, it is possible to perform prediction with accuracy satisfying an application introduction requirement.

Further, the data analysis apparatus 100 according to the embodiment described above may be configured as in the following (1) to (5).

(1) The data analysis apparatus 100 includes the processor 201 that executes a program and the storage device 202 that stores the program. The processor 201 is configured to execute: an acquisition processing (step S801, S802) of acquiring the first statistical model 120 based on a distribution (first affection distribution 102) of actual measurement results (statistical information 101) of a group (for example, adults in a whole country) and the second statistical model 140 based on a distribution (second affection distribution 104) of a first actual measurement result (affection 132 in learning data set 103 of facility A) of first samples (case ID 130 in learning data set 103 of facility A) having a smaller number of samples than the number of samples of the group; a calculation processing (step S803) of calculating the correction information 105 indicating a difference between the first statistical model 120 and the second statistical model 140 acquired by the acquisition processing; a learning processing (step S804) of generating the first prediction model M1 by performing machine learning using the first actual measurement result (affection 132 in learning data set 103 of facility A) and first feature amount data (feature amount f in learning data set 103 of facility A) corresponding to the first actual measurement result (affection 132 in learning data set 103 of facility A); and a correction processing (step S806, S807) of correcting the first prediction result P1 output by inputting second feature amount data (feature amount f in prediction target data 106 of facility B) of second samples (case ID 130 in prediction target data 106 of facility B) different from the first samples (case ID 130 in learning data set 103 of facility A) to the first prediction model M1 generated by the learning processing using the correction information 105 calculated by the calculation processing, and outputting the second prediction result P2.

(2) In the data analysis apparatus 100 according to (1), the processor 201 is configured to execute: additional learning processing (step S809) of updating the first prediction model M1 by performing additional learning using the loss function 108 based on the second prediction result P2 output by the correction processing and the second actual measurement result 107 relating to the second samples (case ID 130 in prediction target data 106 of facility B); and correct, in the correction processing (step S806, S807), using the correction information 105, the third prediction result P1 output by inputting third feature amount data (feature amount f in prediction target data 106 of facility C) of third samples different from the first samples and the second samples to the first prediction model M1 updated by the additional learning processing, and output the fourth prediction result P2.

(3) In the data analysis apparatus 100 according to (1), in the acquisition processing, the processor 201 acquires the updated second statistical model 140 based on a distribution of the first actual measurement result (affection 132 in learning data set 103 of facility A) and a distribution of the second actual measurement result 107, in the calculation processing, the processor 201 calculates the updated correction information 105 indicating a difference between the first statistical model 120 and the updated second statistical model 140, and in the correction processing, the processor 201 corrects a third prediction result (first prediction result P1 in prediction target data 106 of facility C) output by inputting third feature amount data (feature amount f in prediction target data 106 of facility C) of third samples different from the first samples and the second samples to the first prediction model M1 using the updated correction information 105, and outputs a fourth prediction result (second prediction result P2 in prediction target data 106 of facility C).

(4) In the data analysis apparatus 100 according to (1), in the acquisition processing, the processor 201 acquires an updated second statistical model (second statistical model 140 in facilities A and B) based on a distribution (second affection distribution 104 in facilities A and B added by learning data set 400 of facility B) of the first actual measurement result (affection 132 of learning data set 103 of facility A) and a distribution of the second actual measurement result 107, in the learning processing, the processor 201 generates the updated first prediction model M1 by performing re-machine learning using the first actual measurement result (affection 132 of learning data set 103 of facility A), the second actual measurement result 107, the first feature amount data (feature amount f in learning data set 103 of facility A), and the second feature amount data (feature amount f in prediction target data 106 of facility B), and in the correction processing, the processor 201 corrects a third prediction result (first prediction result P1 in prediction target data 106 of facility C) output by inputting third feature amount data (feature amount f in prediction target data 106 of facility C) of third samples different from the first samples and the second samples to the updated first prediction model M1 using the correction information 105, and outputs a fourth prediction result (second prediction result P2 in prediction target data 106 of facility C).

(5) In the data analysis apparatus 100 according to (3), in the learning processing, the processor 201 generates the updated first prediction model M1 by performing re-machine learning using the first actual measurement result (affection 132 of learning data set 103 of facility A), the second actual measurement result 107, the first feature amount data (feature amount f in learning data set 103 of facility A), and the second feature amount data (feature amount f in prediction target data 106 of facility B), and in the correction processing, the processor 201 corrects the third prediction result (first prediction result P1 in prediction target data 106 of facility C) output by inputting the third feature amount data (feature amount f in prediction target data 106 of facility C) of the third samples different from the first samples and the second samples to the updated first prediction model M1 using the updated correction information 105, and outputs the fourth prediction result (second prediction result P2 in prediction target data 106 of facility C).

The invention is not limited to the above embodiment and includes various modifications and equivalent configurations within the spirit of the claims. For example, the embodiment described above has been described in detail in order to make the invention easy to understand, and the invention is not necessarily limited to those having all the described configurations. A part of a configuration of a certain embodiment may be replaced with a configuration of another embodiment. The configuration of another embodiment may be added to the configuration of the certain embodiment. Further, a part of the configuration of each embodiment may be added to, deleted from, or replaced with another configuration.

Further, a part or all of the configurations, functions, processing units, processing methods described above and the like may be implemented by hardware, for example, by designing with an integrated circuit, or may be implemented by software, with the processor 201 to interpret and execute a program for implementing each function.

Information such as a program, a table, and a file that implements each function can be stored in a storage device such as a memory, a hard disk, and a solid state drive (SSD), or a recording medium such as an integrated circuit (IC) card, a SD card, and a digital versatile disc (DVD).

Control lines and information lines according to the embodiments described above indicate what is considered necessary for description, and not all the control lines and the information lines are necessarily shown in a product. In fact, it may be considered that almost all the configurations are connected with each other.

What is claimed is:

1. A data analysis apparatus comprising:
a processor that executes a program; and
a storage device that stores the program, wherein
the processor is configured to execute
an acquisition processing of acquiring a first statistical model based on a distribution of actual measurement results of a group and a second statistical model based on a distribution of a first actual measurement result of first samples having a smaller number of samples than the number of samples of the group,
a calculation processing of calculating correction information indicating a difference between the first statistical model and the second statistical model acquired by the acquisition processing,
a learning processing of generating a first prediction model by performing machine learning using the first actual measurement result and first feature amount data corresponding to the first actual measurement result, and
a correction processing of correcting a first prediction result output by inputting second feature amount data of second samples different from the first samples to the first prediction model generated by the learning processing using the correction information calculated by the calculation processing, and outputting a second prediction result.

2. The data analysis apparatus according to claim 1, wherein
the processor is configured to execute
additional learning processing of updating the first prediction model by performing additional learning using a loss function based on the second prediction result output by the correction processing and a second actual measurement result relating to the second samples, and
correct, in the correction processing, using the correction information, a third prediction result output by inputting third feature amount data of third samples different from the first samples and the second samples to the first prediction model updated by the additional learning processing, and output a fourth prediction result.

3. The data analysis apparatus according to claim 1, wherein
in the acquisition processing, the processor acquires an updated second statistical model based on a distribution of the first actual measurement result and a distribution of a second actual measurement result regarding the second samples,
in the calculation processing, the processor calculates updated correction information indicating a difference between the first statistical model and the updated second statistical model, and
in the correction processing, the processor corrects a third prediction result output by inputting third feature amount data of third samples different from the first samples and the second samples to the first prediction model using the updated correction information, and outputs a fourth prediction result.

4. The data analysis apparatus according to claim 1, wherein
in the acquisition processing, the processor acquires an updated second statistical model based on a distribution of the first actual measurement result and a distribution of a second actual measurement result regarding the second samples,
in the learning processing, the processor generates an updated first prediction model by performing re-machine learning using the first actual measurement result, the second actual measurement result, the first feature amount data, and the second feature amount data, and in the correction processing, the processor corrects a third prediction result output by inputting third feature amount data of third samples different from the first samples and the second samples to the updated first prediction model using the correction information, and outputs a fourth prediction result.

5. The data analysis apparatus according to claim 3, wherein
in the learning processing, the processor generates an updated first prediction model by performing re-machine learning using the first actual measurement result, the second actual measurement result, the first feature amount data, and the second feature amount data, and
in the correction processing, the processor corrects the third prediction result output by inputting the third feature amount data of the third samples different from the first samples and the second samples to the updated first prediction model using the updated correction information, and outputs the fourth prediction result.

6. A data analysis method by a data analysis apparatus including a processor that executes a program and a storage device that stores the program, wherein
the processor is configured to execute
an acquisition processing of acquiring a first statistical model based on a distribution of actual measurement results of a group and a second statistical model based on a distribution of a first actual measurement result of first samples having a smaller number of samples than the number of samples of the group,
a calculation processing of calculating correction information indicating a difference between the first statistical model and the second statistical model acquired by the acquisition processing,
a learning processing of generating a first prediction model by performing machine learning using the first actual measurement result and first feature amount data corresponding to the first actual measurement result, and
a correction processing of correcting a first prediction result output by inputting second feature amount data of second samples different from the first samples to the first prediction model generated by the learning processing using the correction information calculated by the calculation processing, and outputting a second prediction result.

7. A data analysis program that causes a processor to execute:
an acquisition processing of acquiring a first statistical model based on a distribution of actual measurement results of a group and a second statistical model based on a distribution of a first actual measurement result of first samples having a smaller number of samples than the number of samples of the group;
a calculation processing of calculating correction information indicating a difference between the first statistical model and the second statistical model acquired by the acquisition processing;
a learning processing of generating a first prediction model by performing machine learning using the first actual measurement result and first feature amount data corresponding to the first actual measurement result; and
a correction processing of correcting a first prediction result output by inputting second feature amount data of second samples different from the first samples to the first prediction model generated by the learning processing using the correction information calculated by the calculation processing, and outputting a second prediction result.
